(19) United States
(12) Patent Application Publication
(10) Pub. No.: US 2025/0227535 A1
(43) Pub. Date: Jul. 10, 2025

(54) COMMUNICATION CONTROL METHOD AND USER EQUIPMENT

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 19/091,581

(22) Filed: Mar. 26, 2025

Related U.S. Application Data
(63) Continuation of application No. PCT/JP2023/034426, filed on Sep. 22, 2023.

(51) Int. Cl. H04W 24/10; H04W 64/00

(52) U.S. Cl. CPC H04W 24/10; H04W 64/006

(57) ABSTRACT

In an aspect, a communication control method is a communication control method in a mobile communication system. The communication control method includes transmitting, by a user equipment positioned at an altitude equal to or higher than a predetermined threshold value, a measurement report to a network node in accordance with a movement distance of the user equipment.

### RELATED APPLICATIONS

The present application is a continuation based on PCT Application No. PCT/JP2023/034426, filed on Sep. 22, 2023, which claims the benefit of U.S. Provisional Patent Application No. 63/410,362 filed on Sep. 27, 2022. The content of which is incorporated by reference herein in their entirety.

### TECHNICAL FIELD

The present disclosure relates to a communication control method in a mobile communication system.

### BACKGROUND

In the specifications of the Third Generation Partnership Project (3GPP), which is a standardization project for mobile communication systems, an Aerial UE is defined (for example, see Non-Patent Document 1 and Non-Patent Document 2). For example, the Aerial UE can report an altitude or report position information including a vertical velocity and a horizontal velocity. In the 3GPP, communication with the Aerial UE flying in the sky is appropriately supported through such specifications.

### CITATION LIST

### Non-Patent Literature

Non-Patent Document 1: 3GPP TS 36.300 V17.1.0 (2022-6)
Non-Patent Document 2: 3GPP TS 36.331 V17.1.0 (2022-6)

### SUMMARY

In an aspect, a communication control method is a communication control method in a mobile communication system. The communication control method includes transmitting, by a user equipment positioned at an altitude equal to or higher than a predetermined threshold value, a measurement report to a network node (or a network apparatus) in accordance with a movement distance of the user equipment.

In an aspect, a communication control method is a communication control method in a mobile communication system. The communication control method includes the steps of: determining, by a user equipment, a timer value in accordance with a movement speed of the user equipment; and transmitting, by the user equipment, a measurement report to a network node in response to a count value counted by a timer reaching the timer value.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a User Equipment (UE) according to the first embodiment.

FIG. 3 is a diagram illustrating a configuration example of a gNB (base station) according to the first embodiment.

FIG. 4 is a diagram illustrating a configuration example of a protocol stack of a user plane according to the first embodiment.

FIG. 5 is a diagram illustrating a configuration example of a protocol stack of a control plane according to the first embodiment.

FIG. 6 is a diagram illustrating a cell configuration example according to the first embodiment.

FIG. 7 is a diagram illustrating an operation example according to the first embodiment.

FIG. 8 is a diagram illustrating another operation example according to the first embodiment.

FIG. 9 is a diagram illustrating another operation example according to the first embodiment.

FIG. 10 is a diagram illustrating an operation example according to a second embodiment.

### DESCRIPTION OF EMBODIMENTS

A mobile communication system according to an embodiment will be described with reference to the drawings. In the description of the drawings, the same or similar parts are denoted by the same or similar reference signs.

### First Embodiment

### Configuration of Mobile Communication System

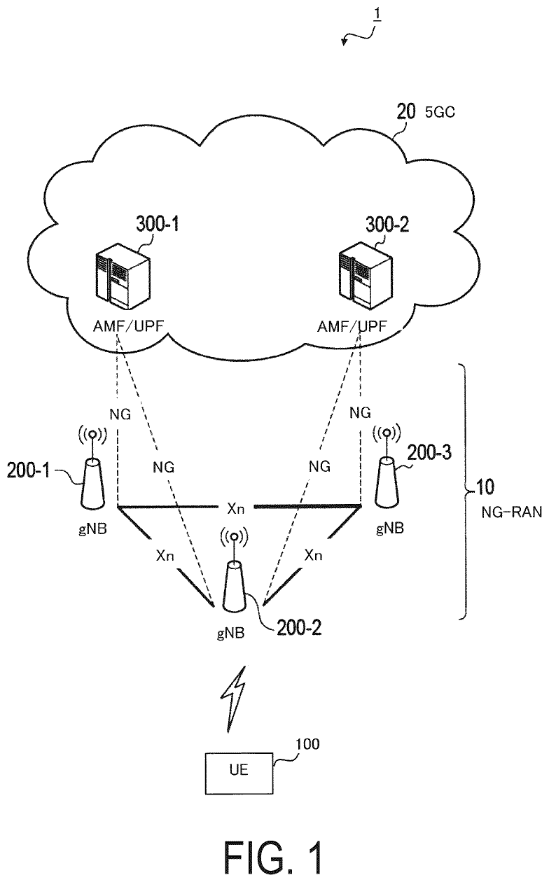

FIG. 1 is a diagram illustrating a configuration of a mobile communication system according to a first embodiment. A mobile communication system 1 complies with a 5th Generation System (5GS) of the 3GPP standards. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the Core Network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided to a sensor, a vehicle or an apparatus provided to a vehicle (Vehicle UE), and a flying object or an apparatus provided to a flying object (Aerial UE).

The NG-RAN 10 includes base stations (referred to as “gNBs” in the 5G system) 200. The gNBs 200 are interconnected via an Xn interface that is an inter-base station interface. Each gNB 200 manages one or more cells. The gNB 200 performs wireless communication with the UE 100 that has established connection to the cell of the gNB 200. The gNB 200 has a Radio Resource Management (RRM) function, a function of routing user data (hereinafter simply referred to as “data”), a measurement control function for mobility control and scheduling, and the like. “Cell” is used as a term representing a minimum unit of a wireless communication area. “Cell” is also used as a term representing a function or a resource for performing wireless communication with the UE 100. One cell belongs to one carrier frequency (hereinafter simply referred to as a “frequency”).

Note that the gNB 200 can also be connected to an Evolved Packet Core (EPC) that is an LTE core network. An LTE base station (evolved Node B (eNB)) can also be connected to the 5GC 20. The LTE base station and the gNB 200 can also be connected via an inter-base station interface.

The 5GC 20 includes an Access and Mobility Management Function (AMF) and a User Plane Function (UPF) 300. The AMF performs various types of mobility control and the like on the UE 100. The AMF manages mobility of the UE 100 by communicating with the UE 100 by using Non-Access Stratum (NAS) signaling. The UPF controls data transfer. The AMF and UPF are connected to the gNB 200 via an NG interface that is an interface between a base station and the core network.

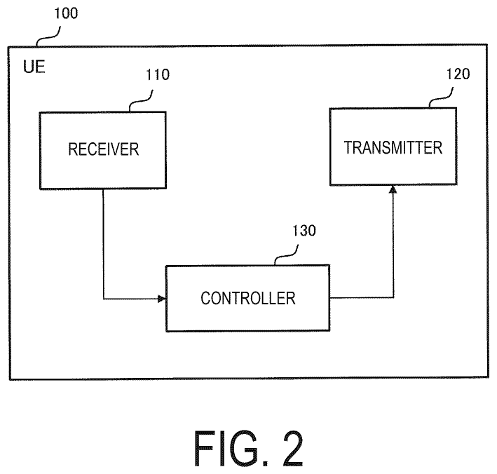

FIG. 2 is a diagram illustrating a configuration example of the user equipment 100 (UE) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (reception signal) and outputs the baseband signal to the controller 130.

The transmitter 120 performs various types of transmission under control of the controller 130. The transmitter 120 includes an antenna and a transmission device. The transmission device converts a baseband signal (transmission signal) output by the controller 130 into a radio signal and transmits the radio signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that the controller 130 may perform all processing or each operation in the UE 100 in each embodiment to be described below.

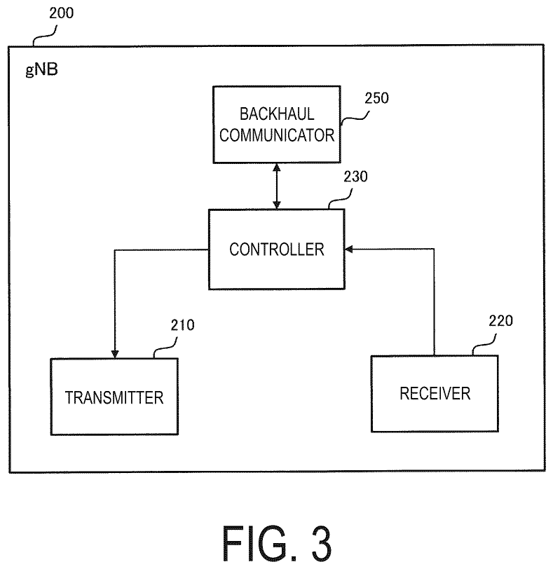

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (transmission signal) output by the controller 230 into a radio signal and transmits the radio signal through the antenna.

The receiver 220 performs various types of reception under control of the controller 230. The receiver 220 includes an antenna and a reception device. The reception device converts a radio signal received through the antenna into a baseband signal (reception signal) and outputs the baseband signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that the controller 230 may perform all processing or each operation in the gNB 200 in each embodiment to be described below.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

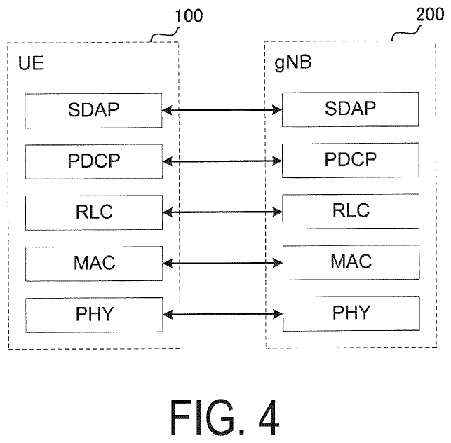

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives Downlink Control Information (DCI) transmitted from the gNB 200 over a Physical Downlink Control CHannel (PDCCH). More specifically, the UE 100 blind decodes the PDCCH using a Radio Network Temporary Identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

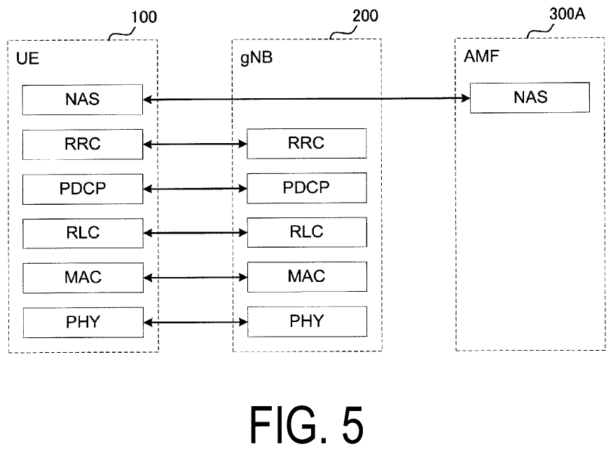

FIG. 5 is a diagram illustrating a configuration of a protocol stack of a radio interface of a control plane handling signaling (control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS that is positioned upper than the RRC layer performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as an Access Stratum (AS).

### UAV

An unmanned aerial vehicle (Unmanned Aerial Vehicle or Uncrewed Aerial Vehicle (UAV). An “unmanned aerial vehicle” may be referred to as a “UAV” below) according to the first embodiment will be described.

The UAV is generally an unmanned aircraft, such as a drone. However, in the first embodiment, a UE positioned at an altitude equal to or higher than a predetermined threshold value (or exceeding the predetermined threshold value) is referred to as a UAV. The UAV may be a UE capable of performing wireless communication with the gNB 200 while flying in the sky in an unmanned manner like an unmanned aircraft. The UAV may be provided to an unmanned aircraft. The UAV may be provided to a manned aircraft. For example, a UE owned by a user on board of an aircraft, while the aircraft is flying at an altitude equal to or higher than a predetermined threshold value, may also be a UAV. The UAV may be a UAV UE. The UAV may be an Aerial UE. The UAV may be distinguished from a UE that is used on the ground. However, when not particularly distinguished from the UE, the UAV may be included in a UE as an example of the UE. In this case, the UAV and the UE may collectively be referred to as the UE. The configuration example of the UE 100 illustrated in FIG. 2 may represent a configuration example of the UAV.

In the 3GPP, a function for supporting an Aerial UE is defined as follows, for example.

First, an Aerial UE can report its altitude. For example, the Aerial UE can report the altitude when its altitude becomes equal to or higher than or equal to or lower than a threshold value. At this time, the Aerial UE can also report position information. The position information may also include a horizontal velocity and a vertical velocity of the Aerial UE.

Second, a network (E-UTRAN) of the LTE system can request the Aerial UE to report flight path information. The flight path information represents a waypoint (passing point information or location point information) on a path of the Aerial UE. The flight path information may include a number of waypoints. The waypoint is represented as three-dimensional position information. The Aerial UE may report time information (time stamp) for each waypoint being included in the flight path information.

Third, whether an Aerial UE is supported (or whether to allow the UE to function as an Aerial UE) is included in subscription information for each user. The subscription information is stored for each user on a Home Subscriber Server (HSS) in the LTE system. Whether the Aerial UE is supported is included in the subscription information. The subscription information is transmitted from the HSS to an eNB that is a base station in the LTE system under control of a Mobility Management Entity (MME). The eNB may recognize whether the UE is allowed to function as an Aerial UE.

Fourth, an event H1 and an event H2 can be used as a trigger condition for a measurement report. The event H1 represents an event condition when the altitude of the Aerial UE exceeds the threshold value. On the other hand, the event H2 represents an event condition when the altitude of the Aerial UE falls below the threshold value. These event conditions are each determined whether the condition is met by using a hysteresis value, an offset value, and a threshold value in addition to the altitude.

As described above, matters defined in the 3GPP are based on the assumption that the Aerial UE (i.e., the UAV) is used in the LTE system.

On the other hand, in the 3GPP, discussion on introduction of the UAV in NR (New Radio) has begun. With regard to the UAV, agreement has been made in the 3GPP. The agreement includes to use the above-mentioned event H1 and event H2, to report an altitude, a position, and a velocity of the UAV, to report a flight path plan, and the like.

### Terrestrial Cell and Sky Cell

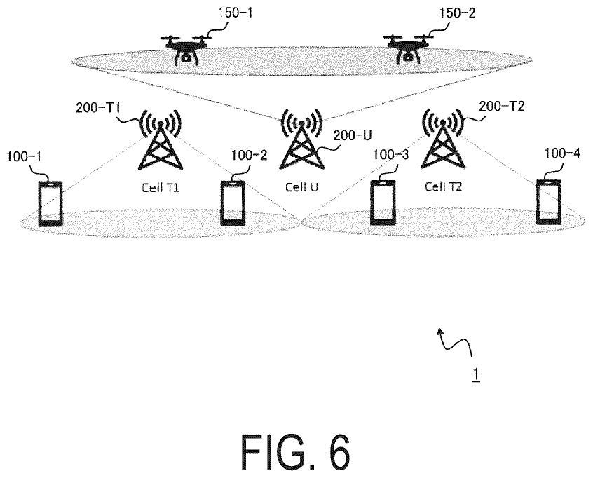

For example, it is assumed that a terrestrial cell and a sky cell coexist in a network. FIG. 6 is a diagram illustrating a cell configuration example of the case described above.

As illustrated in FIG. 6, a mobile communication system 1 includes terrestrial cells and a sky cell. In the example illustrated in FIG. 6, the terrestrial cells are constituted of a gNB 200-T1 and a gNB 200-T2, respectively, and the sky cell is constituted of a gNB 200-U. FIG. 6 illustrates an example in which UEs 100-1 to 100-4 each perform wireless communication with either the gNB 200-T1 or the 200-T2 in the terrestrial cell, and UAVs 150-1 and 150-2 each perform wireless communication with the gNB 200-U in the sky cell.

Here, in order for the UEs 100-1 to 100-4 to appropriately perform wireless communication in the terrestrial cells and in order for the UAVs 150-1 and 150-2 to appropriately perform wireless communication in the sky cell, the following two scenarios are assumed.

In the first scenario, a dedicated frequency is assigned to the sky cell, and different frequencies are used in the terrestrial cell and the sky cell. In the first scenario, for example, since wireless communication by the UAVs 150-1 and 150-2 and wireless communication by the UEs 100-1 to 100-4 is performed by using different frequencies, interference between the two wireless communications can be avoided.

On the other hand, in the second scenario, the same frequency (or the same frequency range) is used in the terrestrial cell and the sky cell. In the second scenario, since the frequency is shared by the terrestrial cell and the sky cell, frequency resources need not be specifically increased. Therefore, in the second scenario, effective use of frequency resources can be achieved.

### Communication Control Method According to First Embodiment

The first embodiment is an embodiment relating to a measurement report.

The measurement report is, for example, information transmitted when the UE 100 satisfies a predetermined condition relating to an event trigger. The gNB 200 (or eNB) that has received the measurement report can cause the UE 100 to be handed over to a neighboring cell based on the measurement report.

Here, in the LTE system, a case is assumed in which the event H1 is configured for an Aerial UE as an event condition. In such a case, an Aerial UE will satisfy the event condition of the event H1 as long as the altitude of the Aerial UE is exceeding a threshold value. Therefore, an Aerial UE may continue to transmit the measurement report at a report interval (ReportInterval) (the report interval is, for example, a regular interval to transmit the measurement report). That is, there is a problem that an Aerial UE transmits the measurement report more often than a UE on the ground and overhead increases. The same and/or a similar problem is supposed to occur even when a specific event condition (for example, event H1 or event H2) is introduced to NR.

On the other hand, regarding the measurement report, it is also conceivable to solve the problem of the overhead of the measurement report by providing a prohibition timer and not transmitting the measurement report during the prohibition timer. The prohibit timer is, for example, the time during which processing is not performed.

However, even when the prohibit timer is configured for the UAV 150, a movement distance during the prohibit timer may vary in accordance with a speed of the UAV 150, and a radio condition may greatly vary as well. When the UAV 150 moves too much, a radio link failure (RLF) or a handover failure (HOF) may occur for a certain number of times or more. Accordingly, in the mobile communication system 1, an avoidance process for the RLF or the HOF can possibly not be performed.

In the first embodiment, it is an object of the present disclosure that the number of measurement reports for the UAV 150 is appropriately controlled.

Therefore, in the first embodiment, a user equipment (for example, UAV 150) positioned at an altitude equal to or higher than a predetermined threshold value transmits a measurement report to a base station (for example, gNB 200) in accordance with a movement distance of the user equipment.

Since the UAV 150 can transmit the measurement report in accordance with the movement distance, the number of measurement reports of the UAV 150 may be controlled, as compared with a case that the prohibit timer is less than a predetermined time, for example. In addition, since the UAV 150 can transmit a measurement report in accordance with the movement distance, the measurement report corresponding to the radio condition may appropriately be transmitted, as compared with a case that the prohibit timer is equal to or longer than a predetermined time, for example. Accordingly, in the first embodiment, the number of measurement reports may appropriately be controlled.

### Operation Example According to First Embodiment

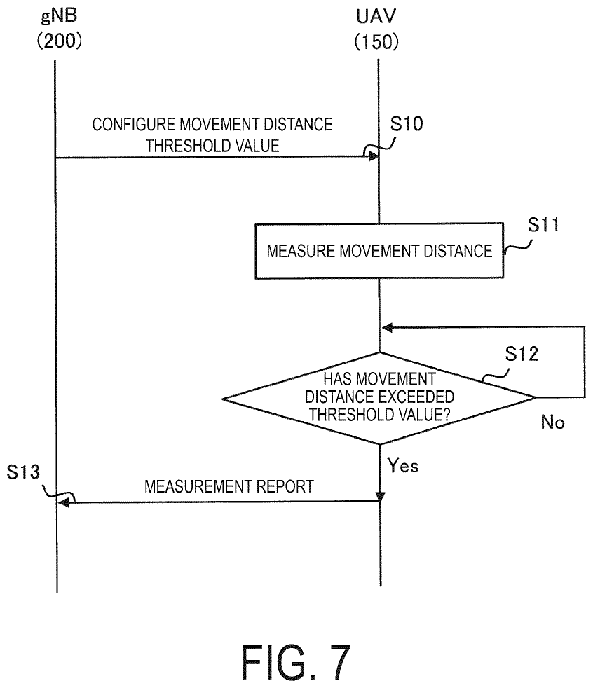

FIG. 7 is a diagram illustrating an operation example according to the first embodiment.

As illustrated in FIG. 7, the gNB 200 configures a distance threshold value for the UAV 150 in step S10. The distance threshold value is, for example, a threshold value used by the UAV 150 to determine whether to transmit a measurement report in accordance with its own movement distance. The distance threshold value may be represented in units expressing length (such as meters, centimeters, or yards). The distance threshold value may be represented by latitude and longitude. In the following description, the distance threshold value is described as being represented by a unit expressing length (for example, meters). The gNB 200 may configure the distance threshold value by transmitting an RRC setup (RRCSetup) message including the distance threshold value for the UAV 150. The gNB 200 may configure the distance threshold value by broadcasting system information (SIB) including the distance threshold value. The gNB 200 may transmit a measurement configuration including the distance threshold value to the UAV 150 by using an RRC message (for example, RRC reconfiguration (RRCReconfiguration) message or RRC resume (RRCResume) message) to configure the distance threshold value for the UAV 150.

In step S11, the UAV 150 measures the movement distance. The UAV 150 may measure the speed per unit time by a speed sensor and multiply (or integrate) the speed by the time measured by a timer to measure the movement distance. The UAV 150 may use a global navigation satellite system (GNSS) receiver to measure the movement distance. The movement distance may be expressed in a planar direction (longitudinal and/or lateral direction, or latitude and longitude direction). The movement distance may be represented by a three-dimensional direction (height direction). The distance threshold value may also be represented in the same direction as the movement distance.

In step S12, the UAV 150 determines whether the movement distance exceeds the distance threshold value (or whether the movement distance is equal to or greater than the distance threshold value). In Step S12, when the movement distance exceeds the distance threshold value (Yes in Step S12), the process proceeds to Step S13. On the other hand, in step S12, when the movement distance does not exceed the distance threshold value (No in step S12), step S12 is repeated until the movement distance exceeds the distance threshold value.

Note that the condition for transmitting the measurement report in accordance with the movement distance (more specifically, step S12) may be hereinafter referred to as a “movement distance condition”.

In step S13, the UAV 150 transmits the measurement report to the gNB 200. With regard to transmitting the measurement report, the UAV 150 may use any one of the prohibit timer or the report interval for reporting the measurement report in combination with the movement distance condition. That is, the UAV 150 may transmit the measurement report upon exceeding the movement distance over the distance threshold value, even when the prohibit timer (or report interval) has not expired. The UAV 150 may reset the count value of the timer that counts the prohibit timer (or report interval) in response to the measurement report transmission. After transmitting the measurement report, the UAV 150 resets the measured movement distance and resumes measuring the movement distance.

Note that the UAV 150 may transmit the measurement report upon expiring of the prohibit timer (or report interval) even when the movement distance does not exceed the distance threshold value (or when the movement distance is equal to or less than the distance threshold value) (No in step S12). For example, when the UAV 150 is hovering in the sky, the UAV 150 does not move, and thus the movement distance does not become equal to or greater than the distance threshold value. Even in such a case, the prohibit timer (or report interval) may be used so that the UAV 150 can transmit the measurement report every predetermined time (i.e., every time any one of the prohibit timer or the report interval expires).

### Another Example 1 of First Embodiment

Another example 1 of the first embodiment will be described. In the other example 1 of the first embodiment, differences from the first embodiment will mainly be described.

The other example 1 of the first embodiment is an example in which the measurement of the movement distance described in the first embodiment (step S11 in FIG. 7) is started when the event condition is satisfied. More specifically, when the user equipment (for example, UAV 150) determines that the event condition is satisfied, measurement of the movement distance is started. Thus, for example, in the UAV 150, the measurement report can be transmitted using the event condition and the movement distance condition in combination.

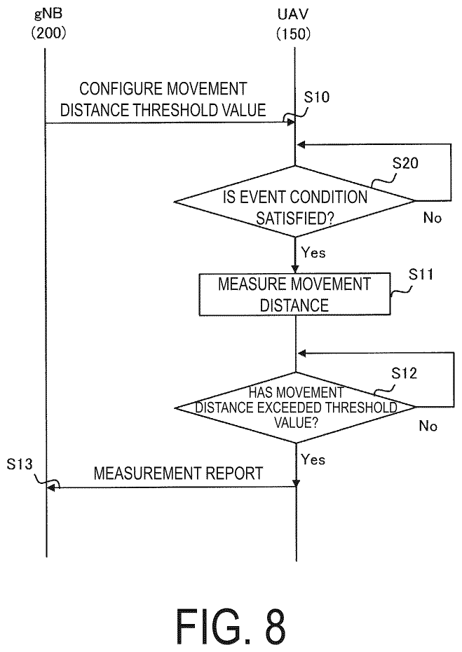

FIG. 8 is a diagram illustrating an operation example according to the other example 1 of the first embodiment. In FIG. 8, the same processing portions as those of the first embodiment are denoted by the same reference signs.

As illustrated in FIG. 8, when the distance threshold value is configured (step S10), the UAV 150 determines, in step S20, whether the event condition is satisfied. Upon determining that the event condition is satisfied (Yes in step S20), the UAV 150 starts measuring the movement distance (step S11). On the other hand, when the UAV 150 determines that the event condition is not satisfied (No in step S20), the process is repeated until the event condition is satisfied.

The event used for the event condition may be any event, and may be an event defined by the 3GPP. Such an event may be, for example, the above-described event H1 or event H2. Such an event may be an event A3. The event A3 is an event indicating that radio quality of a neighboring cell is higher than the radio quality of the primary cell.

The gNB 200 may configure the UAV 150 to measure the movement distance when the event condition is satisfied. In this case, the gNB 200 may transmit a measurement configuration, including the event condition and the distance threshold value, for the UAV 150 to perform the configuration. Alternatively, the gNB 200 may transmit a measurement configuration, including information indicating that the movement distance is to be measured upon satisfying the event condition, for the UAV 150 to perform the configuration.

Note that the UAV 150 may perform the measurement report upon satisfying the event condition (Yes in step S20). Then, the UAV 150 may start the measurement of the movement distance by making the performance of the measurement report as the event condition. Since the event condition is satisfied when the measurement report is performed in step S13, the UAV 150 may restart the measurement of the movement distance. In the case above, the UAV 150 repeats the measurement of the movement distance after performing the measurement report.

### Another Example 2 of First Embodiment

Another example 2 of the first embodiment will be described. In the other example 2 of the first embodiment, differences from the first embodiment will mainly be described.

The other example 2 of the first embodiment is an example in which the UAV 150 transmits the measurement report when both the event condition and the movement distance condition are satisfied. More specifically, a user equipment (for example, UAV 150) transmits a measurement report to a base station (for example, gNB 200) based on a movement distance (for example, a movement distance condition) and an event condition. Thus, for example, also in the other example 2 of the first embodiment, for example, in the UAV 150, the measurement report can be transmitted by using the event condition and the movement distance condition in combination.

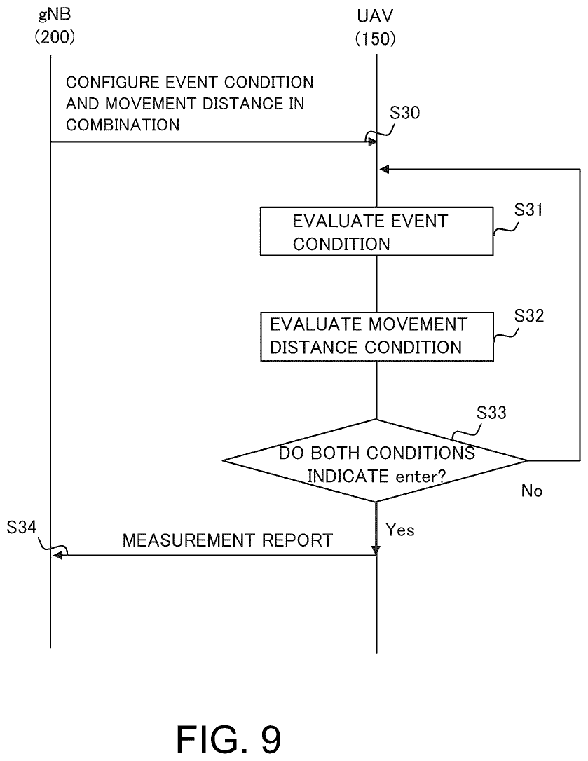

FIG. 9 is a diagram illustrating an operation example according to the other example 2 of the first embodiment.

As illustrated in FIG. 9, in step S30, the gNB 200 configures the UE 100 to use the movement distance condition and the event condition in combination. The gNB 200 may transmit a measurement configuration, including information indicating that the movement distance condition and the event condition are used in combination, for the UAV 150 by using an RRC message to perform the configuration. Alternatively, the gNB 200 may transmit the measurement configuration, including the distance threshold value and an application event, for the UAV 150 by using an RRC message to perform the configuration. The event used for the event condition may be an event defined by the 3GPP (for example, event A3, event A5, event H1, event H2, or the like), as in the other example 1 of the first embodiment.

In step S31, the UAV 150 evaluates the event condition. Upon satisfying the event condition, the UAV 150 goes into an enter state. On the other hand, upon not satisfying the event condition, the UAV 150 goes into a leave state.

In step S32, the UAV 150 evaluates the movement distance condition. When the movement distance of the UAV 150 is equal to or greater than the distance threshold value (or the UAV 150 exceeds the distance threshold value), the UAV 150 goes into the enter state. On the other hand, when the movement distance of the UAV 150 is less than the distance threshold value (or the movement distance is equal to or less than the distance threshold value), the UAV 150 goes into the leave state. The measurement of the movement distance may be the same as in the first embodiment (step S11). The order of step S31 and step S32 may be reversed.

In step S33, the UAV 150 determines whether the two conditions of the event condition and the movement distance condition both indicate the enter state. Upon the two conditions both indicating the enter state (Yes in step S33), the UAV 150 transmits the measurement report to the gNB 200 (step S34). That is, the UAV 150 transmits the measurement report to the gNB 200 when the movement distance exceeds the distance threshold value and the event condition is satisfied. On the other hand, when both the two conditions do not indicate the enter state (No in step S33), the UAV 150 proceeds to step S31 again and repeats the above-described processing. That is, the UAV 150 does not transmit the measurement report in at least one of a case that the movement distance is equal to or less than the distance threshold value and a case that the event condition is not satisfied.

### Second Embodiment

A second embodiment will be described. In the second embodiment, differences from the first embodiment will mainly be described.

In the second embodiment, an example will be described in which the prohibit timer (or report interval) is changed (hereinafter, such a change may be referred to as “scaling”) in accordance with the movement speed of the UAV 150. The prohibit timer above is the prohibit timer described in the first embodiment. In addition, the report interval above may be the report interval for reporting the measurement report described in the first embodiment.

More specifically, first, the user equipment (for example, UAV 150) determines a timer value (for example, prohibit timer or report interval) in accordance with the movement speed of the user equipment. Second, the user equipment transmits the measurement report to the base station (for example, gNB 200) in response to the count value counted by the timer reaching the timer value.

Accordingly, for example, in the UAV 150, since the measurement report can be transmitted in accordance with the movement speed, the number of transmissions of the measurement report may be controlled, as compared with a case that the timer value is constant. Therefore, in the mobile communication system 1 according to the second embodiment, the number of measurement reports may appropriately be controlled.

The prohibit timer (or report interval) may be scaled as follows, for example. That is, when the movement speed of the UAV 150 is equal to or higher than a speed threshold value (i.e., when the UAV 150 is moving at a high speed), the UAV 150 determines the timer value to be less than a time threshold value. In addition, for example, when the movement speed of the UAV 150 is less than the speed threshold value (i.e., when the UAV 150 is moving at a low speed), the UAV 150 determines the timer value to be equal to or greater than the time threshold value. With the scaling described above, when the movement speed of the UAV 150 is equal to or higher than the speed threshold value (i.e., when the UAV 150 is moving at a high speed), the timer value is less than the time threshold value. Thus, the number of measurement reports may appropriately be controlled, as compared with a case that the prohibit timer or report interval is constant. Further, with the scaling described above, when the movement speed of the UAV 150 is less than the speed threshold value (i.e., when the UAV 150 is moving at a low speed), the timer value becomes equal to or greater than the time threshold value. Thus, even in a state that the UAV 150 is hovering, the UAV 150 may appropriately transmit the measurement report.

### Operation Example According to Second Embodiment

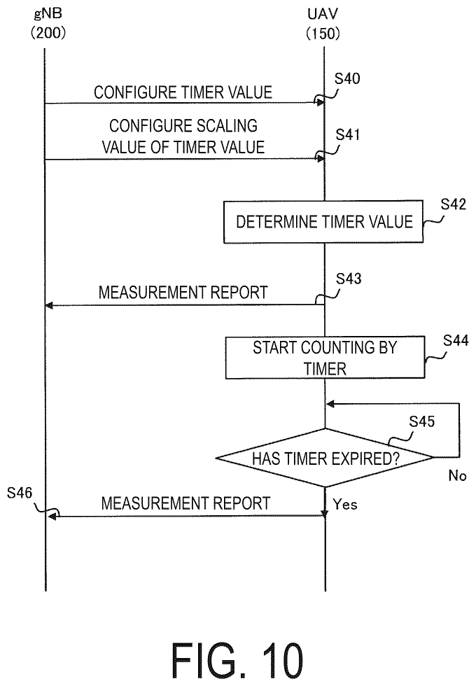

FIG. 10 is a diagram illustrating an operation example according to the second embodiment.

As illustrated in FIG. 10, in step S40, the gNB 200 configures a configuration timer value for the UAV 150. The configuration timer value may be represented by either the prohibit timer or the report interval for reporting a measurement report. The gNB 200 may transmit a measurement configuration including the configuration timer value to the UAV 150 by using an RRC message to configure the configuration timer value.

In step S41, the gNB 200 configures a scaling value for the UAV 150. The gNB 200 may transmit the measurement configuration including the scaling value to the UAV 150 by using an RRC message to configure the scaling value.

The order of step S40 and step S41 may be reversed. The two configurations of step S40 and step S41 may be combined into one. When the two configurations are combined into one, the gNB 200 may transmit one measurement configuration including the timer value and the scaling value to the UAV 150 by using one RRC message.

In step S42, the UAV 150 determines the timer value. For example, the UAV 150 determines, as the timer value, the value obtained by scaling the configuration timer value with the scaling value corresponding to the movement speed. More specifically, the UAV 150 may determine the timer value as follows.

First, the UAV 150 may determine, as the timer value, a value obtained by multiplying the scaling value by the movement speed of the UAV 150 and dividing the configuration timer value by the multiplication value ([configuration timer value]÷{[scaling value]×[movement speed of UAV 150]}). As the movement speed of the UAV 150 becomes higher, the timer value becomes smaller. The timer value is a value determined in accordance with the movement speed. The UAV 150 may determine the timer value by measuring its own movement speed and substituting each value into the above equation. The measuring method of the movement speed may be the same as in the first embodiment.

Second, the UAV 150 may determine, as the timer value, a value obtained by multiplying the configuration timer value by the scaling value for each movement state of the UAV 150 ([configuration timer value]×[scaling value for each movement state of UAV 150]). The movement state of the UAV 150 represents a state classified in accordance with the movement speed of the UAV 150. For example, the movement state of the UAV 150 may be a “stationary state” when the movement speed of the UAV 150 is from “0” to less than a first speed threshold value, a “low speed movement state” when the movement speed of the UAV 150 is equal to or higher than the first speed threshold value and equal to or less than a second speed threshold value (first speed threshold value<second speed threshold value), and a “high speed movement state” when the movement speed of the UAV 150 exceeds the second speed threshold value. For example, the scaling value configured by the gNB 200 may be “1” in the “stationary state”, “0.5” in the “low speed movement state”, and “0.2” in the “high speed movement state”. The UAV 150 measures its own movement speed, confirms the movement state corresponding to the movement speed, and determines the timer value by using the scaling value corresponding to the movement state. The measuring method of the movement speed may be the same as in the first embodiment.

In step S43, the UAV 150 starts counting by the timer in response to the transmission of the measurement report. The UAV 150 may start counting by the timer at a predetermined timing.

In step S44, the UAV 150 determines whether the count value by the timer has reached the timer value (i.e., whether the timer value has expired).

When the count value reaches the timer value (Yes in step S45), the UAV 150 transmits the measurement report to the gNB 200 in step S46. That is, the UAV 150 transmits the measurement report in response to the timer expiring.

On the other hand, when the count value does not reach the timer value (No in step S45), the UAV 150 waits until the count value reaches the timer value (No in step S45). That is, the UAV 150 will suspend the transmission of the measurement report until the timer expires.

Note that, when the movement state of the UAV 150 changes during the counting by the timer value (i.e., during operation of the timer), the UAV 150 may change the timer value. When the timer value is changed, the count value by the timer may be restarted without being reset. Alternatively, when the timer value is changed, the count value may be reset considering that the timer has expired (or the count value has reached the timer value).

### Other Embodiments

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps need not be necessarily performed, and only some of the steps may be performed. In the embodiments and the examples described above, an example in which the base station is an NR base station (i.e., a gNB) is described. However, the base station may be an LTE base station (i.e., an eNB) or a 6G base station. The base station may be a relay node such as an Integrated Access and Backhaul (IAB) node. The base station may be the DU of the IAB node. The UE 100 may be a Mobile Termination (MT) of the IAB node.

The term “network node” mainly refers to a base station, but may also refer to a core network apparatus or a part of a base station (the CU, the DU or an RU).

A program causing a computer to execute each of the processing performed by the UE 100 or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “in accordance with/in response to” used in the present disclosure do not mean “based only on” and “only in accordance with/only in response to”, respectively, unless specifically stated otherwise. The phrase “based on” means both “based only on” and “based at least in part on”. The phrase “in accordance with” means both “only in accordance with” and “at least partially in accordance with”. The terms “include”, “comprise”, and variations thereof do not mean including only items stated, but means including only items stated or including other items in addition to the items stated. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

An embodiment has been described above in detail with reference to the drawings, but specific configurations are not limited to those described above, and various design variations can be made without departing from the gist of the present disclosure. All or some of the embodiments, operations, processes, and steps may be combined without being inconsistent.

### SUPPLEMENTARY NOTES

Supplementary Note 1

A communication control method in a mobile communication system, the communication control method including:
transmitting, by a user equipment positioned at an altitude equal to or higher than a predetermined threshold value, a measurement report to a network node in accordance with a movement distance of the user equipment.
Supplementary Note 2

The communication control method according to Supplementary Note 1, wherein the transmitting includes transmitting, by the user equipment, the measurement report to the network node when the movement distance exceeds a distance threshold value.
Supplementary Note 3

The communication control method according to Supplementary Note 1 or 2, wherein the transmitting of the measurement report to the network node when the movement distance exceeds the distance threshold value includes transmitting, by the user equipment, the measurement report to the network node every predetermined time, when the movement distance is equal to or less than the distance threshold value.
Supplementary Note 4

The communication control method according to any one of Supplementary notes 1 to 3, wherein the predetermined time is any one of a prohibit timer or a report interval at which the measurement report is reported.
Supplementary Note 5

The communication control method according to any one of Supplementary Notes 1 to 4, further including:
configuring, by the network node, the distance threshold value for the user equipment.
Supplementary Note 6

The communication control method according to any one of Supplementary Notes 1 to 5, wherein the transmitting includes starting, by the user equipment, measurement of the movement distance upon determining that an event condition is satisfied.
Supplementary Note 7

The communication control method according to any one of Supplementary Notes 1 to 6, wherein the transmitting includes transmitting, by the user equipment, the measurement report to the network node based on the movement distance and an event condition.
Supplementary Note 8

The communication control method according to any one of Supplementary notes 1 to 7, wherein the transmitting of the measurement report to the network node based on the movement distance and the event condition includes transmitting, by the user equipment, the measurement report to the network node when the movement distance exceeds a distance threshold value and the event condition is satisfied.
Supplementary Note 9

The communication control method according to any one of Supplementary Notes 1 to 8, further including:
configuring, by the network node, the user equipment to use the movement distance and the event condition in combination.
Supplementary Note 10

A communication control method in a mobile communication system, the communication control method including the steps of:
determining, by a user equipment, a timer value in accordance with a movement speed of the user equipment; and
transmitting, by the user equipment, a measurement report to a network node in response to a count value counted by a timer reaching the timer value.
Supplementary Note 11

The communication control method according to Supplementary Note 10, wherein the determining includes setting, by the user equipment, the timer value to be less than a time threshold value when the movement speed is equal to or higher than a speed threshold value, and setting the timer value to be equal to or greater than the time threshold value when the movement speed is less than the speed threshold value.
Supplementary Note 12

The communication control method according to Supplementary Note 10 or 11, further including:
configuring, by the network node, a configuration timer value and a scaling value for the user equipment,
wherein the determining includes determining, by the user equipment, a value obtained by scaling the configuration timer value with the scaling value corresponding to the movement speed as the timer value.

1. A communication control method in a mobile communication system, the communication control method comprising:
transmitting, by a user equipment positioned at an altitude equal to or higher than a predetermined threshold value, a measurement report to a network node in accordance with a movement distance of the user equipment.

2. The communication control method according to claim 1, wherein the transmitting comprises transmitting, by the user equipment, the measurement report to the network node when the movement distance exceeds a distance threshold value.

3. The communication control method according to claim 2, wherein the transmitting of the measurement report to the network node when the movement distance exceeds the distance threshold value comprises transmitting, by the user equipment, the measurement report to the network node every predetermined time, when the movement distance is equal to or less than the distance threshold value.

4. The communication control method according to claim 3, wherein the predetermined time is any one of a prohibit timer or a report interval at which the measurement report is reported.

5. The communication control method according to claim 2, further comprising:
configuring, by the network node, the distance threshold value for the user equipment.

6. The communication control method according to claim 1, wherein the transmitting comprises starting, by the user equipment, measurement of the movement distance upon determining that an event condition is satisfied.

7. The communication control method according to claim 1, wherein the transmitting comprises transmitting, by the user equipment, the measurement report to the network node based on the movement distance and an event condition.

8. The communication control method according to claim 7, wherein the transmitting of the measurement report to the network node based on the movement distance and the event condition comprises transmitting, by the user equipment, the measurement report to the network node when the movement distance exceeds a distance threshold value and the event condition is satisfied.

9. The communication control method according to claim 7, further comprising:
configuring, by the network node, the user equipment to use the movement distance and the event condition in combination.

10. A communication control method in a mobile communication system, the communication control method comprising the steps of:
determining, by a user equipment, a timer value in accordance with a movement speed of the user equipment; and
transmitting, by the user equipment, a measurement report to a network node in response to a count value counted by a timer reaching the timer value.

11. The communication control method according to claim 10, wherein the determining comprises setting, by the user equipment, the timer value to be less than a time threshold value when the movement speed is equal to or higher than a speed threshold value, and setting the timer value to be equal to or greater than the time threshold value when the movement speed is less than the speed threshold value.

12. The communication control method according to claim 11, further comprising:
configuring, by the network node, a configuration timer value and a scaling value for the user equipment,
wherein the determining comprises determining, by the user equipment, a value obtained by scaling the configuration timer value with the scaling value corresponding to the movement speed as the timer value.

13. A user equipment in a mobile communication system, the user equipment comprising:
a transmitter configured to transmit a measurement report to a network node in accordance with a movement distance of the user equipment when positioned at an altitude equal to or higher than a predetermined threshold value.
